(19) United States
(12) Patent Application Publication
(10) Pub. No.: US 2022/0068140 A1
(43) Pub. Date: Mar. 3, 2022

(54) SHARED TRIP PLATFORM FOR MULTI-VEHICLE PASSENGER COMMUNICATION

(71) Applicant: GM Cruise Holdings LLC, San Francisco, CA (US)

(72) Inventors: Jeffrey Brandon, Phoenix, AZ (US); Alexander Willem Gerrese, San Francisco, CA (US); Jeremy Stephen Juel, San Francisco, CA (US); Yifei Zhang, San Francisco, CA (US)

(73) Assignee: GM Cruise Holdings LLC, San Francisco, CA (US)

(21) Appl. No.: 17/009,124

(22) Filed: Sep. 1, 2020

(51) Int. Cl. G08G 1/00; G06Q 50/30; G06Q 50/00; B60W 30/165; B60W 60/00; G08G 1/01; G01C 21/34; H04N 21/2187; H04N 7/18; H04N 21/472

(52) U.S. Cl. CPC G08G 1/22; B60W 2420/42; G06Q 50/01; B60W 30/165; B60W 60/00276; G08G 1/0112; G08G 1/0145; G08G 1/0141; G01C 21/3492; H04N 21/2187; H04N 7/185; H04N 21/47217; B60W 2556/65; B60W 2756/10; G06Q 50/30

(57) ABSTRACT

A fleet management system provides a shared trip platform that virtually connects multiple autonomous vehicles (AVs). Multiple AVs, each transporting at least one passenger, are connected in a shared trip. Each of the AVs provides an audio/video stream of the passenger compartment and a current location to a server. The shared trip platform provides a display in each of the AVs showing the current locations of the two AVs in the shared trip. The shared trip platform also transmits the audio/video streams to AVs connected in the shared trip, enabling a video chat between the passengers in the connected AVs.

### TECHNICAL FIELD OF THE DISCLOSURE

The present disclosure relates generally to coordination and communication between vehicle passengers and, more specifically, to methods and systems for providing a shared trips platform that connects passengers within multiple associated vehicles.

### BACKGROUND

Passengers traveling in a group are limited by the number of seats in a single vehicle. When the group splits between different vehicles, their sense of togetherness is fractured, and social interactions are interrupted. In addition, if the group is traveling to the same location, the vehicles may not arrive at the same drop-off point, which leads to confusion and delays among the group as they attempt to find each other at the destination. To maintain group cohesion during travel, a large group can request a bus or limousine service, but such services are expensive and often are not readily available on-demand.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system including a fleet of autonomous vehicles (AVs) that can implement a shared trips platform according to some embodiments of the present disclosure;

FIG. 2 is a diagram illustrating two AVs that can be connected in a shared trip according to some embodiments of the present disclosure;

FIG. 3 is a diagram illustrating a coordinated ride provided by two AVs that can be connected in a shared trip according to some embodiments of the present disclosure;

FIG. 4 is a diagram illustrating a passenger compartment of an AV according to some embodiments of the present disclosure;

FIG. 5 is an example shared trip interface showing real-time video from another AV according to some embodiments of the present disclosure;

FIG. 6 is an example shared trip interface showing real time locations of multiple AVs according to some embodiments of the present disclosure;

FIG. 7 is an example shared trip interface showing multiple shared trip features according to some embodiments of the present disclosure;

FIG. 8 is a block diagram showing the fleet management system according to some embodiments of the present disclosure; and

FIG. 9 is a flowchart of an example method for real-time interaction between AVs according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

A fleet management system described herein provides a shared trip platform that connects passengers riding in multiple different autonomous vehicles (AVs). For example, the shared trip platform maintains social cohesion between a group of people being transported from a pickup location to a destination location when the group splits into multiple AVs. The shared trip platform keeps the passengers informed about the AVs' progress, e.g., by showing the locations of all of the AVs in the shared trip on a map. The shared trip platform also provides video chat between the AVs, so that social connection is maintained. While users' personal devices can be used to maintain some connection between passengers in different vehicles, e.g., by using shared location features, texting, and video calls, such features can be cumbersome and difficult to use in a vehicle setting. Location sharing, texting, video chat, and other interactive features are each provided by different services that users must separately agree to and configure, which is inconvenient. Furthermore, using such features on a mobile device drains battery. In addition, relying on personal devices to facilitate interaction makes it difficult for users to perform other tasks on their devices, as they would be able to during an in-person interaction. The shared trip platform instantly provides a number of interactive features that more closely replicate the experience of being together in a single vehicle.

As used herein, a “shared trip” is a trip that involves multiple passengers across multiple AVs. The fleet management system provides a virtual connection between the passengers while the passengers are physically separated in different AVs. The shared trip may involve passengers traveling between the same pickup location and destination location. Alternatively, the shared trip may involve passengers traveling from more than one pickup location (e.g., passengers' respective homes or workplaces) and to the same destination location; from the same pickup location (e.g., a venue attended by multiple passengers) and to different destination locations (e.g., passengers' respective homes); or between different pickup locations and different destination locations (e.g., a long-distance couple may create a shared trip to share their morning commutes). The fleet management system may create the shared trip based on a ride request (e.g., if a user requests a coordinated ride that involves multiple AVs traveling between a pickup location and destination location), or users may request to join or create shared trips while in transit.

The shared trip platform is enabled by hardware components included in the passenger compartment of the AV. In particular, the passenger compartment of each AV includes one or more display screens, one or more speakers, one or more microphones, and one or more video cameras. The video cameras and microphones capture real-time video and audio of the passengers, and the AV transmits the captured video and audio to the fleet management system. The fleet management system passes on the captured video and audio to one or more other AVs connected to the AV in the shared trip platform to enable a real-time audio/video connection between the connected AVs. In addition, each AV continuously monitors its current location using GPS sensors and other localization sensors. The AVs provide their current locations to the fleet management system, and the fleet management system groups the real-time locations of the connected AVs into a single interface available to all passengers.

The shared trip platform may enable other interactive group features. For example, a passenger in one AV may select media (e.g., a song or video) to be played across all of the AVs in the shared trip. Each AV in the shared trip plays the selected media for its passengers. As another example, the shared trip platform may facilitate group games and activities, such as charades and karaoke.

Embodiments of the present disclosure provide a system for providing real-time interaction between two AVs that includes a trip sharing manager, a map module, and an AV interface. The trip sharing manager is configured to receive from a first user traveling in a first AV of a fleet of AVs, a request to join a shared trip with a second user, the second user traveling in a second AV of the fleet of AVs; and, in response to the request, connect the first AV and the second AV in a shared trip. The map module is configured to provide a current location of the first AV to the second AV for display on an in-vehicle interface of the second AV. The AV interface is configured to receive a real-time video stream from the first AV, the real-time video stream captured by a camera in a passenger compartment of the first AV; and provide the real-time video stream to the in-vehicle interface of the second AV.

Embodiments of the present disclosure also provide a system for providing real-time interaction between two AVs that includes a plurality of AVs and a fleet management system. Each of the plurality of AVs includes a location sensor system configured to determine a current location of the AV, at least one interior camera configured to capture images of a passenger of the AV, at least one interior microphone configured to capture audio of the passenger of the AV, and at least one interior display screen configured to provide an in-vehicle interface to the passenger of the AV. The fleet management system is configured to receive an instruction to form a shared trip between a first AV and a second AV of the plurality of AVs; provide a map showing the current location of the first AV and the current location of the second AV to the in-vehicle interface of the second AV; receive an audio/video stream from the first AV, the audio/video stream including images captured by the at least one interior camera and audio captured by the at least one interior microphone; and provide the audio/video stream to the in-vehicle interface of the second AV.

Embodiments of the present disclosure also provide for a method for real-time interaction between two AVs that includes receiving a request to form a shared trip between a first AV and a second AV of a fleet of AVs; receiving, from the first AV, a current location of the first AV determined by a location sensor system; providing a map showing the current location of the first AV and the current location of the second AV to an in-vehicle interface of the second AV; receiving an audio/video stream from the first AV, the audio/video stream including images captured by at least one interior camera of the first AV and audio captured by at least one interior microphone of the first AV; and providing the audio/video stream to the second AV, the second AV configured to output the audio/video stream on the in-vehicle interface.

As will be appreciated by one skilled in the art, aspects of the present disclosure, in particular aspects of a shared trip platform, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV System for Implementing the Shared Trip Platform

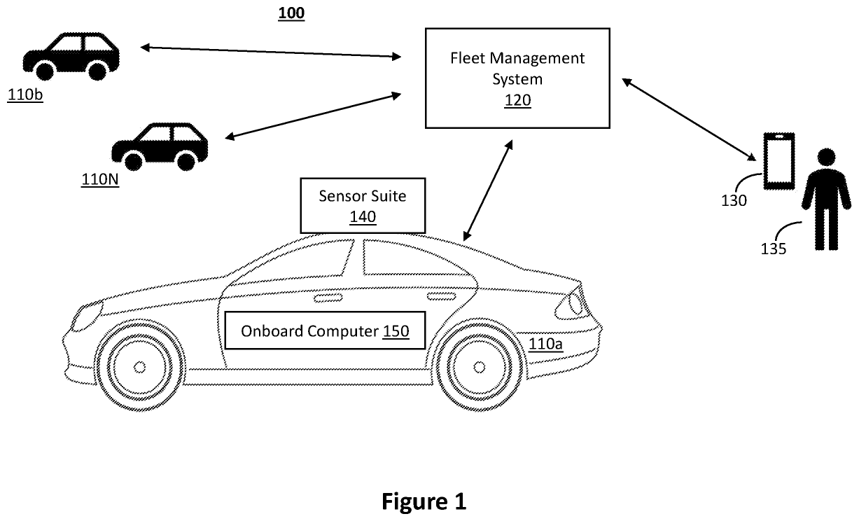

FIG. 1 is a block diagram illustrating a system 100 including a fleet of AVs that can implement a shared trip platform, according to some embodiments of the present disclosure. The system 100 includes a fleet of AVs 110, including AV 110a, AV 110b, and AV 110N, a fleet management system 120, and a user device 130. For example, a fleet of AVs may include a number N of AVs, e.g., AV 110a through AV 110N. AV 110a includes a sensor suite 140 and an onboard computer 150. AVs 110b through 110N also include the sensor suite 140 and the onboard computer 150. A single AV in the fleet is referred to herein as AV 110, and the fleet of AVs is referred to collectively as AVs 110.

The fleet management system 120 receives service requests for the AVs from user devices, such as user device 130. For example, a user 135 accesses an app executing on the user device 130 and requests a ride from a pickup location (e.g., the current location of the user device 130) to a destination location. The user device 130 transmits the ride request to the fleet management system 120. The fleet management system 120 selects an AV from the fleet of AVs 110 and dispatches the selected AV to the pickup location to carry out the ride request. In some embodiments, the ride request further includes a number of passengers in the group. For example, if each AV 110 includes four passenger seats, and the fleet management system 120 receives a request to provide a ride to ten passengers, the fleet management system 120 selects three AVs from the fleet to transport the group of passengers.

The fleet management system 120 and AVs 110 implement a shared trip platform that connects passengers across multiple AVs. For example, a passenger in one AV, e.g., AV 110a, can identify another passenger riding in another AV, e.g., AV 110b, to the fleet management system 120, and the fleet management system 120 creates a shared trip to connect AV 110a to AV 110b. Using interfaces within the AVs 110a and 110b, the passengers can engage in real-time communication and monitor the other passenger's progress throughout their rides.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

The AV 110 includes a sensor suite 140, which includes a computer vision (“CV”) system, localization sensors, and driving sensors. For example, the sensor suite 140 may include interior and exterior cameras, radar sensors, sonar sensors, lidar (light detection and ranging) sensors, thermal sensors, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110.

The sensor suite 140 includes a location sensor system that collects data used to determine a current location of the AV 110. The location sensor system may include a GPS sensor and one or more IMUs. The location sensor system may further include a processing unit (e.g., a module of the onboard computer 150, or a separate processing unit) that receives signals (e.g., GPS data and IMU data) to determine the current location of the AV 110. The location determined by the location sensor system is used for route and maneuver planning. In addition, a current location is transmitted on a periodic basis (e.g., every 5 seconds, or every minute) to the fleet management system 120, which tracks the current locations of the AVs 110.

The onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. The onboard computer 150 is preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

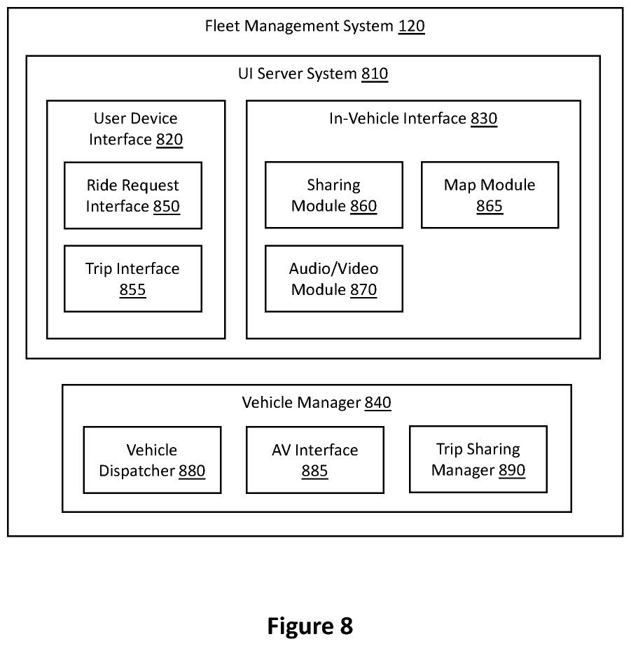

The fleet management system 120 manages the fleet of AVs 110. The fleet management system 120 may manage one or more services that provides or uses the AVs, e.g., a service for providing rides to users using the AVs. The fleet management system 120 selects one or more AVs (e.g., AVs 110a and 110b) from a fleet of AVs 110 to perform a particular service or other task, and instructs the selected AV(s) (e.g., AVs 110a and 110b) to drive to a particular location (e.g., an address to pick up a user or a group of passengers). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a public network, such as the Internet. The fleet management system 120 is described further in relation to FIG. 8.

The user device 130 is a personal device of the user 135, e.g., a smartphone, tablet, computer, or other device for interfacing with a user of the fleet management system 120. The user device 130 may provide one or more applications (e.g., mobile device apps or browser-based apps) with which the user 135 can interface with a service that provides or uses AVs, such as a service that provides passenger rides. The service, and particularly the AVs associated with the service, is managed by the fleet management system 120, which may also provide the application to the user device 130. The application may provide a user interface to the user 135 during the rides, such as a map showing the locations of the AVs 110 transporting the group of passengers. Some of all of the other passengers in the group associated with the user 135 may have their own user devices similar to user device 130. These other user devices can interface with the fleet management system 120 in a similar manner.

### Example Shared Trip Use Case—Separately Dispatched Rides

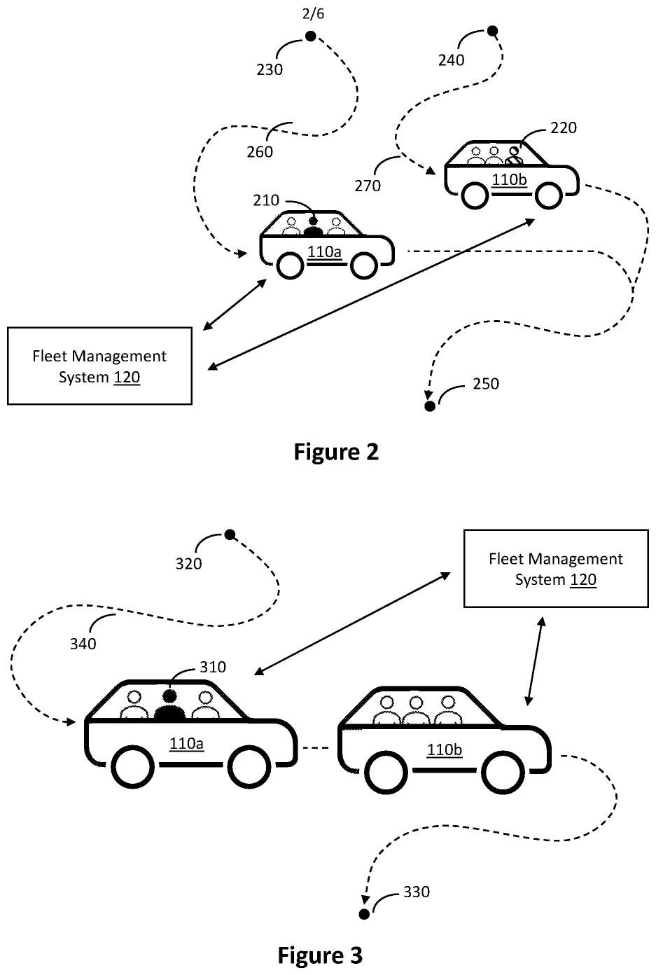

FIG. 2 illustrates a shared trip connecting passengers in two AVs. In this example, two groups of passengers, including passengers 210 and 220, are traveling to a destination location 250. The first group of passengers is riding in a first AV 110a, and is traveling from a first pickup location 230 to the destination location 250. The second group of passengers is riding in a second AV 110b, and is traveling from a second pickup location 240 to the destination location 250. The fleet management system 120 dispatches the two AVs 110a and 110b to provide rides to the passengers responsive to separate requests from the two groups of passengers.

For example, the fleet management system 120 receives one ride request from passenger 210, also referred to as a first requesting user 210, and a second ride request from passenger 220, also referred to as a second requesting user 220. Each of the ride requests includes a respective pickup location 230 or 240 and the destination location 250. The fleet management system 120 selects the AVs 110a and 110b to service the two respective ride requests, e.g., by identifying AVs in the fleet that are available and proximate to the pickup locations 230 and 240. The fleet management system 120 may select an AV that has the shortest estimated drive time to the pickup location, or an AV that is the shortest distance from the pickup location. The fleet management system 120 may consider additional factors in selecting the AV from a set of available AVs in the fleet, such as fuel level of the AVs, geographic distribution of AVs, and other ride requests. The fleet management system 120 instructs each of the AVs 110a and 110b to drive to the respective pickup location 230 and 240 and pick up passengers according to the ride requests. The fleet management system 120 further instructs the first AV 110a to drive along a route 260 from the first pickup location 230 to the destination location 250, and instructs the second AV 110b to drive along a route 270 from the second pickup location 240 to the destination location 250. In some examples, the two pickup locations 230 and 240 are the same location, and/or the AVs 110a and 110b are traveling to different destination locations.

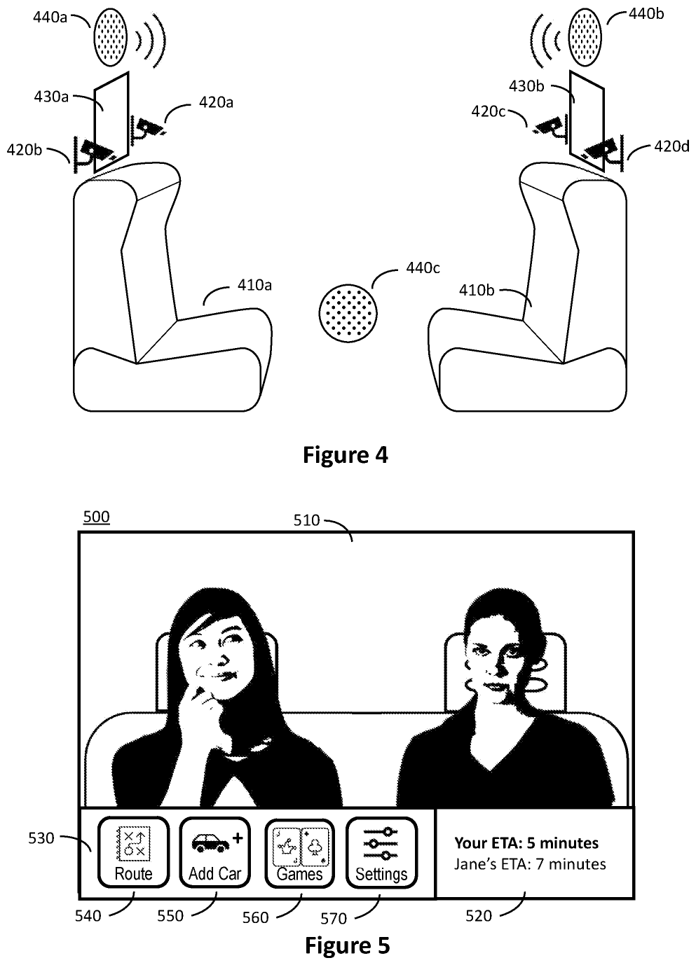

The first requesting user 210 or the second requesting user 220 can request to form a shared trip between the AVs 110a and 110b. For example, the first requesting user 210 inputs contact information, such as a phone number or email address, of the second requesting user 220 into a shared trip user interface on the first requesting user's personal device or a shared trip user interface in the first AV 110a. The fleet management system 120 transmits an invitation to join a shared trip with the first requesting user 210 to the second requesting user 220 via a user interface on the second requesting user's personal device and/or an interface in the AV 110b. If the second requesting user 220 accepts the invitation, the fleet management system 120 creates and implements a shared trip that connects the passengers in the first AV 110a with the passengers in the second AV 110b as they travel to the destination location 250. In some embodiments, additional AVs can join the shared trip with the first AV 110a and second AV 110b in a similar manner. Various shared trip features are described further with respect to FIGS. 4-8.

### Example Shared Trip Use Case—Coordinated Ride

FIG. 3 is a diagram illustrating a shared trip connecting passengers in a coordinated ride provided by two AVs 110a and 110b. In this example, rather than receiving one ride request for each AV, the fleet management system 120 receives a request for a coordinated ride, in which multiple AVs service a single ride request. For example, a requesting user 310 submits a request for a ride for all of the passengers shown in FIG. 3 to the fleet management system 120. The ride request includes a pickup location 320, a destination location 330, and a number of passengers (here, six passengers) to be transported from the pickup location 320 to the destination location 330. In some embodiments, instead of or in addition to requesting a ride for a specific number of passengers, the requesting user 310 requests a specific number of AVs (e.g., two AVs).

If the ride request includes a number of passengers, the fleet management system 120 compares the number of passengers in the ride request to a passenger capacity for the AVs 110 and, if the number of passengers is greater than the passenger capacity, the fleet management system 120 arranges a multi-AV coordinated ride for the group. The fleet management system 120 determines a number of AVs to service the group, e.g., by dividing the number of passengers by the passenger capacity of the AVs and rounding up any remainder. As an example, if each AV 110 can seat four passengers, and the ride request is for six passengers, the fleet management system 120 determines that two AVs 110 (1.5, rounded up to 2) are sufficient to transport the number of passengers in the ride request. In some embodiments, the fleet management system 120 requests confirmation from the requesting user 310 to accept the coordinated ride service.

The fleet management system 120 selects a set of AVs (here, AVs 110a and 110b) to provide the coordinated ride, e.g., by identifying AVs in the fleet that are available and proximate to the pickup location 320, in a similar manner to that described with respect to FIG. 2. The fleet management system 120 transmits dispatch instructions to the selected AVs 110a and 110b instructing the selected AVs 110a and 110b to drive autonomously to the pickup location 320 and pick up the passengers according to the ride request. The fleet management system 120 further instructs the AVs 110a and 110b to drive along a route 340 from the pickup location 320 to the destination location 330. Further details describing coordinated rides are provided in U.S. application Ser. No. 17/008,816, filed Sep. 1, 2020, the entirety of which is incorporated by reference herein.

The fleet management system 120 automatically connects the two AVs 110a and 110b in a shared trip. The shared trip platform provides various features for connecting the passengers in the AVs 110a and 110b en route from the pickup location 320 to the destination location 330. The shared trip features are described further with respect to FIGS. 4-8.

### Example AV Passenger Compartment

FIG. 4 is a diagram illustrating a passenger compartment of an AV 110 according to some embodiments of the present disclosure. The passenger compartment includes two rows of seats 410a and 410b that are arranged facing each other. Each row of seats 410a and 410b can seat a fixed number of passengers, e.g., two passengers or three passengers. The passenger compartment is further equipped with video cameras 420a, 420b, 420c, and 420d. The video cameras 420 are components of the sensor suite 140. Each video camera 420 is configured to capture images of a portion of the passenger compartment. In this example, each row of seats 410a and 410b has two video cameras above it and facing the opposite row of seats. For example, if the row of seats 410a is configured to seat two passengers, the video camera 420c is positioned to capture images of a passenger sitting on the left side of the row of seats 410a, and the video camera 420d is positioned to capture images of a passenger sitting on the right side of the row of seats 410a. The video cameras 420 may include microphones for capturing audio, e.g., voices of passengers in the passenger compartment. Alternatively, the passenger compartment may be equipped with one or more separate microphones.

The passenger compartment further includes various output devices, such as display screens 430a and 430b, and speakers 440a, 440b, and 440c. In this example, a display screen 430 is above each of the rows of seats 410a and 410b and viewable to the row of seats positioned opposite. For example, passengers seated in the row of seats 410a can view the display screen 430b. The display screens 430 may be equipped to receive user input, e.g., through one or more buttons arranged proximate to each display screen 430, or through a touch screen. In other embodiments, one or more user input devices are located elsewhere in the passenger compartment, e.g., on an armrest, and a passenger can control the display screens 430 and/or speakers 440 using the user input devices. In other embodiments, a user can provide user input through an interface on a personal user device (e.g., an app running on the user device 130). In some embodiments, the display screens 430a and 430b are controlled individually. In other embodiments, the display screens 430a and 430b can be controlled separately, so that a passenger seated in the row of seats 410a has a different view on the display screen 430b than a passenger seated in the row of seats 410b has on the display screen 430a. The speakers 440a, 440b, and 440c provide audio output to the passenger compartment. The speakers 440 may be located at different points throughout the passenger compartment, and the speakers 440 may be individually or jointly controlled.

The video cameras 420 are in communication with the onboard computer 150, and each outputs a captured video stream to the onboard computer 150. The microphones (either in the video cameras 420 or separate microphones) are also in communication with the onboard computer 150, and each outputs a captured audio stream to the onboard computer 150. The onboard computer 150 transmits the captured audio and video, or a portion of the captured audio and video, to the fleet management system 120. In some embodiments, the onboard computer 150 identifies seats in the passenger compartment in which passengers are seated, and transmits captured video for those seats to the fleet management system 120, but does not transmit captured video for empty seats.

To determine whether a seat has a seated passenger, the onboard computer 150 may perform an image detection algorithm on images captured by each of the video cameras 420. As another example, the passenger compartment includes weight sensors incorporated into the passenger seats that transmit weight measurements to the onboard computer 150, and the onboard computer 150 determines based on the weight measurements whether each seat has a seated passenger. In other embodiments, the onboard computer 150 uses one or more other interior sensors (e.g., lidar, radar, thermal imaging, etc.) or a combination of sensors to identify the locations of passengers seated in the AV 110. In some embodiments, the onboard computer 150 instructs video cameras 420 directed at seats that have seated passengers to capture video, while other video cameras 420 do not capture video.

In some embodiments, the display screens 430 and the speakers 440 are in communication with and are controlled by the onboard computer 150. In other embodiments, the display screens 430 and speakers 440 may be controlled by a separate computer (e.g., a computer integrated one of the display screens 430 or located elsewhere in the AV 110). The computer controlling the display screens 430 and speakers 440 is in communication with the fleet management system 120. The computer controlling the display screens 430 and speakers 440 can receive user input from one or more input sources described above, such as a touch screen, microphone, buttons, user interface device, personal user device, or one or more other user input devices. The computer controlling the display screens 430 and speakers 440 may or may not interact with the onboard computer 150.

In alternate configurations, the passenger compartment has rows of seats in different configurations (e.g., two rows facing the same direction), more rows of seats, fewer rows of seats, one or more individual seats (e.g., bucket seats), or some combination of seats (e.g., one bench seat and two bucket seats). The arrangement of the video cameras 420 and display screens 430 may be different from the arrangement shown in FIG. 4 based on the arrangement of the seats. In particular, the passenger compartment includes one or more display screens that are visible to each of the passenger seats, and video cameras that are positioned to capture a view of each passenger seat. In some embodiments, a single video camera 420 can capture a view of multiple passenger seats.

### Example Shared Trip Interfaces

FIG. 5 is an example shared trip interface 500 showing real-time video from another AV according to some embodiments of the present disclosure. The shared trip interface 500 may be displayed by one or both of the display screens 430 shown in FIG. 4. The shared trip interface 500 includes a real-time video 510 showing a video captured in the other AV. For example, the shared trip interface 500 is displayed by a display screen 430 in the first AV 110a, which is engaged in a shared trip with the second AV 110b. One of the video cameras 420 in the second AV 110b captures a video of two passengers in the second AV 110b. The second AV 110b transmits the video to the fleet management system 120, which transmits the video to the first AV 110a. The first AV 110a displays the received video 510 on a display screen 430 in the first AV 110a. If additional AVs or additional passengers (e.g., passengers in one AV that cannot be captured by a single camera) are included in the shared trip, the shared trip interface 500 may be modified to show additional camera views. An example shared trip interface with multiple camera views is shown in FIG. 7.

The shared trip interface 500 also includes estimated time of arrival (ETA) information for AVs in the shared trip. In this example, an ETA box 520 provides the ETA of the first AV 110a as “Your ETA,” and the ETA of the second AV 110b as “Jane's ETA.” If additional AVs are included in the shared trip, their ETAs may also be listed in the ETA box 520.

The shared trip interface 500 includes additional options 530 that the user may select using a user input device. In this example, the additional options 530 include a route option 540, an add car option 550, a games option 560, and a settings option 570. In response to receiving a user selection of one of the options, the display screen 430 provides an additional interface component relating to the option. The shared trip interface 500 may adjust (e.g., shrink or move) one or more of the interface components 510, 520, and 530 to add the additional interface component, or the shared trip interface 500 may display the additional interface component as a pop-up over the current interface. Different options can be included in other embodiments. For example, other options are described with respect to FIG. 7.

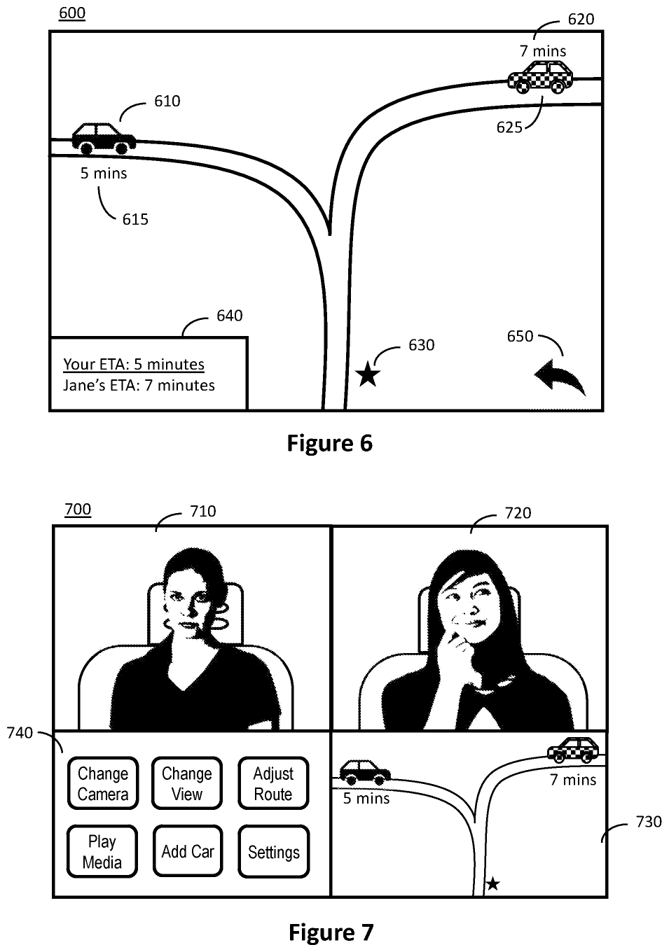

Selecting route option 540 opens a route interface in which a user can view and adjust a route driven by the AV 110a, e.g., by changing the destination location, or adding a stop. The route interface may show the current locations of the AVs in the shared trip on a map, e.g., as shown in FIG. 6. Selecting the add car option 550 opens an add car interface with which a user can add another AV 110 to the shared trip. For example, the add car interface allows the user to search for another AV 110 or another passenger in an AV, e.g., by name, phone number, or email address. The add car interface allows the user to submit a request to a passenger in another AV to join the shared trip.

Selecting the games option 560 opens a games interface in which the user can select an interactive game to play with passengers in the other AVs in the shared trip. For example, the shared trip platform may provide a charades game that displays prompts for passengers in one AV (e.g., the first AV 110a) to act out for passengers in another AV (e.g., the second AV 110b). The passengers in the second AV 110b view the video stream of the acting passengers on the display screen 430 and try to guess the prompts. The shared trip platform may enable other interactive games between AVs in the shared trip, such as trivia, drawing games, card games, board games, etc. In some embodiments, the shared trip platform provides other types of interactive activities, such as a karaoke service that plays music on the speakers 440 and displays lyrics on the display screens 430 of each of the AVs connected in a shared trip. During karaoke, the video cameras 420 continue to capture sound (including singing) and video of the passengers, and the fleet management system 120 transmits the captured sounds and video to the other AVs in the shared trip.

Selecting the settings option 570 opens a settings interface to adjust settings, such as audio/video settings (e.g., volume, brightness, etc.), camera settings (e.g., whether to share video or not), microphone settings (e.g., mute/unmute), user interface settings (e.g., which graphical elements are displayed and how), or other types of settings relating to the shared trip or, more generally, to the AV passenger experience.

FIG. 6 is an example shared trip interface 600 showing real time locations of multiple AVs according to some embodiments of the present disclosure. The display screen 430 may display the shared trip interface 600 in response to a user selecting the route option 540 in FIG. 5. The shared trip interface 600 displays a map with one icon 610 showing a current location of the AV displaying the shared trip interface 600 (e.g., the first AV 110a) and another icon 620 showing a current location of an AV in a shared trip (e.g., the second AV 110b). The shared trip interface 600 further includes an icon 630 showing the destination location on the same map.

In this example, each of the icons 610 and 620 has a label showing the respective AV's ETA. In particular, the icon 610 for the first AV 110a has an associated ETA 615 of 5 minutes, and the icon 620 for the second AV 110b has an associated ETA 625 of 7 minutes. In addition, or alternatively, the shared trip interface includes the ETA box 640, which is similar to the ETA box 520 in FIG. 5. The shared trip interface 600 further includes a back icon 650 that a user may select to return to a prior interface, such as the shared trip interface 500. In other embodiments, the shared trip interface 600 may include additional options and controls, such as the additional options 530 shown in FIG. 5.

Each of the AVs in the shared trip provides its location to the fleet management system 120. In some embodiments, the fleet management system 120 aggregates the locations for the various AVs in the shared trip, generates a map showing each of the locations of the AVs in the shared trip, and transmits the map for display in the shared trip interface 600.

In other embodiments, the location of the AV displaying the shared trip interface 600 (e.g., the location of AV 110a) is received from the onboard computer 150, e.g., from the location sensor system, and displayed directly on the shared trip interface 600, without being relayed to the fleet management system 120. This may allow the location of the AV 110a to update more rapidly, e.g., if the AV 110a sends a current location on one periodic basis (e.g., every 5 seconds) but computes its current location on a more frequent periodic basis (e.g., every second). The computer that generates the shared trip interface 600 plots the location of the AV 110a received from the location sensor system and the location(s) of the other AV(s) in the shared trip (e.g., the location of AV 110b) received from the fleet management system 120 on a map to generate the shared trip interface 600.

FIG. 7 is an example shared trip interface 700 showing multiple shared trip features according to some embodiments of the present disclosure. The display screen 430 may display the shared trip interface 700 by default, or in response to a user selecting an option for a windowed display that shows various camera views, optionally along with one or more additional features. The shared trip interface 700 includes four windows 710, 720, 730, and 740 of equal size. In other configurations, the shared trip interface 700 can include more or fewer windows, and the windows may be of equal or unequal size.

Two video windows 710 and 720 are included. Each of the video windows 710 and 720 is a view captured by a different interior video camera 420. The video windows 710 and 720 may show videos captured within the same AV 110, e.g., by video cameras 420a and 420c in the second AV 110b. Alternatively, the video windows 710 and 720 may show videos captured by different AVs. For example, if two other AVs are participating in a shared trip with the AV 110a (e.g., the second AV 110b and a third AV 110c), one of the video windows 710 shows a passenger in the second AV 110b, and the other video window 720 shows a passenger in the third AV 110c. As another example, one of the video windows 710 shows a self-view of the passenger in the AV 110a, while the other video window 720 shows a passenger in the second AV 110b.

The shared trip interface 700 further includes a map window 730. The map window 730 is a smaller version of the shared trip interface 600 shown in FIG. 6. The map window 730 shows the locations of the first AV 110a and second AV 110b, the ETAs of the first AV 110a and the second AV 110b, and the destination location to which the two AVs 110a and 110b are traveling.

The shared trip interface further includes an options panel 740. In this example, the options panel 740 includes adjust route, add car, and settings options, which may provide interfaces similar to those described with respect to FIG. 5. The options panel further includes a change camera option, change view option, and play media option. Selecting the change camera option opens a camera selection interface in which a user can select one or more camera views from the AV 110a to provide to the other AVs in the shared trip. For example, a passenger can toggle a camera directed at the passenger on or off. As another example, a passenger can toggle on a different interior camera or an exterior camera to show something to passengers in the other AVs in the shared trip. For example, if the AV 110a is passing an interesting building, a passenger in the AV 110a can select an exterior camera showing the building to stream to the other AVs in the shared trip.

Selecting the change view option opens a view selection interface in which a user can change the setup of the shared trip interface 700. For example, the view selection interface can allow the passenger to turn self-view on or off, turn the map window on or off, or toggle on other windows or features. The play media option opens a play media interface that allows the passenger to select and play media, such as music or videos, in the AV 110a. The play media interface may provide an option for the passenger to stream the media to other AVs in the shared trip as well. The play media interface may provide a media library from which the passenger can select media to play. In some embodiments, the play media interface allows a passenger to select media from another source, e.g., a media app on the user's personal user device, and stream media selected on the personal user device to the AV 110a and, optionally, to other AVs in the shared trip, e.g., the second AV 110b.

### Example Fleet Management System

FIG. 8 is a block diagram showing the fleet management system according to some embodiments of the present disclosure. The fleet management system 120 includes a UI server system 810 and a vehicle manager 840. The UI server system 810 includes a user device interface 820 and an in-vehicle interface 830. The user device interface 820 includes a ride request interface 850 and a trip interface 855. The in-vehicle interface 830 includes a sharing module 860, a map module 865, and an audio/video module 870. The vehicle manager 840 includes a vehicle dispatcher 880, an AV interface 885, and a trip sharing manager 890. In alternative configurations, different and/or additional components may be included in the fleet management system 120. Further, functionality attributed to one component of the fleet management system 120 may be accomplished by a different component included in the fleet management system 120 or a different system than those illustrated.

The UI server system 810 comprises one or more servers configured to communicate with client devices that provide user interfaces to users. For example, the UI server system 810 includes a web server that provides a browser-based application to client devices. As another example, the UI server system 810 includes a mobile app server that interfaces with a client app installed on client devices. The client devices that interact with the UI server system 810 include personal user devices, such as the user device 130, and devices mounted in the AVs 110, such as the display screens 430 and speakers 440 mounted in the passenger compartment of the AVs. In the example shown in FIG. 8, the UI server system 810 includes a user device interface 820 that enables user interfaces on personal devices, and an in-vehicle interface 830 that enables user interfaces on in-vehicle devices. Each of the user device interface 820 and in-vehicle interface 830 may be implemented by one or more servers. In other examples, the UI server system 810 may have different architectures for carrying out the functionalities described below.

The user device interface 820 provides interfaces to personal user devices, such as smartphones, tablets, and computers. The user device interface 820 may provide one or more apps or browser-based interfaces that can be accessed by users, such as the users 135, 210, 220, and 310. The user device interface 820 includes the ride request interface 850, which enables the users to submit requests to a ride service provided or enabled by the fleet management system 120. In particular, the ride request interface 850 enables a user to submit a ride request that includes any of the information described with respect to FIGS. 2 and 3, including a pickup location, a drop-off location, and, in some cases, a number of passengers.

The user device interface 820 provides a trip interface 855 to users during their trips. The trip interface 855 may include all of or a subset of the features of the in-vehicle interface 830. For example, the trip interface 855 provides a user's current location and an ETA to their destination and, in a shared trip, provides location and ETA for other AVs associated with the shared trip. Furthermore, the trip interface 855 may provide one or more features supporting the shared trip interactions. For example, the trip interface 855 connects to a contacts list on the user's device and enables a user to select one or more contacts to join in a shared trip. As another example, the trip interface 855 connects to a media app (e.g., a music app or video app) on the user's device and enables the user to select media to play on the AV 110 and the other AVs in the shared trip. Requests submitted through the trip interface 855, such as a request to join another user in a shared trip, or a request to play media in a shared trip, are received at the UI server system 810 and passed to the vehicle manager 840, described below.

The in-vehicle interface 830 provides interfaces to the display screens 430 of the AV 110, such as the interfaces shown in FIGS. 5 through 7, and to other in-vehicle output devices, such as the speakers 440. In some embodiments, the UI server system 810 provides instructions to the display screens 430 for generating various in-vehicle interfaces 830 that incorporate data received from the fleet management system 120, e.g., from the vehicle manager 840. In such examples, the in-vehicle interfaces 830 may incorporate data from the onboard computer 150, such as a self-view video, or a current location of the AV 110. In other embodiments, the UI server system 810 generates full interfaces (e.g., the example displays shown in FIGS. 5-7) and transmits the displays to an AV for display.

The sharing module 860 is an interface through which a passenger can submit a request to join a shared trip. For example, the sharing module 860 allows the passenger to enter contact information for another user. The sharing module 860 transmits the request to the trip sharing manager 890, and the trip sharing manager 890 identifies another AV based on the request and instructs the sharing module 860 to display the request to join the shared trip to the other AV. For example, a first user of the AV 110a submits a request to join a shared trip with a second user, either through the sharing module 860 or the trip interface 855. The request includes contact information (e.g., a name, phone number, and/or email address) identifying the second user. The UI server system 810 passes the request to the trip sharing manager 890. The trip sharing manager 890 identifies another AV 110b associated with the second user. The trip sharing manager 890 instructs the UI server system 810 to display a sharing module 860 in the second AV 110b, this sharing module 860 including an invitation for the second user to join a shared trip with the first user. If the second user accepts the invitation via the sharing module 860, the UI server system 810 receives a signal from the second AV 110b indicating that the second user accepted, and the UI server system 810 forwards the acceptance to the trip sharing manager 890. The trip sharing manager 890 then connects the first AV 110a and the second AV 110b in a shared trip. The sharing module 860 can provide additional interface features related to the shared trip, such as an option to end a shared trip, and an option to add an additional AV to the shared trip.

The map module 865 provides maps to the AVs, such as the maps shown in FIGS. 6 and 7. The map module 865 incorporates, or instructs AVs to incorporate, various location and timing data into a display. For example, the map module 865 provides a current location of a first AV 110a to the second AV 110b for display on the display screen 430. The map module 865 may combine a base map with location data showing the locations of any AVs joined in a shared trip (e.g., the locations of AV 110a and 110b). The map module 865 may further plot other locations related to the shared trip, including the pickup location(s) and destination location(s). Methods for generating the map interface are described further with respect to FIG. 6. The map module 865 may further receive the ETAs for the AVs in the shared trip. For example, the AVs 110 or the vehicle manager 840 may compute an ETA for each AV and provide the ETAs to the map module 865, and the map module 865 provides the ETAs to the AVs 110 for display on the display screen 430, e.g., as shown in FIGS. 5 through 7.

The audio/video module 870 provides audio and video streams to the AVs 110 and interfaces through which a user can view and control the audio and video settings of the shared trip. The audio/video module 870 receives video and audio streams captured by one AV (e.g., the first AV 110a) and transmits the video and audio streams to another AV (e.g., the second AV 110b) in a shared trip with the first AV. For example, the audio/video module 870 can display the video windows shown in FIGS. 5 and 7. The audio/video module 870 may enable a user to adjust the video windows, e.g., by displaying more or fewer windows, or adjusting the windows' relative size. The audio/video module 870 may also provide an interface with which a user can select a particular camera from the video cameras 420 and/or exterior video cameras to stream to the other users in the shared trip, as described with respect to FIG. 7. As another example, the audio/video module 870 provides an interface through which a user can enter a media playback request. The audio/video module 870 may further instruct the AVs in the shared trip to stream and play the media according to the request. In some embodiments, the user submits the media playback request through the trip interface 855, as described above, and can further control media playback through the audio/video module 870.

The in-vehicle interface 830 can include additional modules for providing additional shared trip features. For example, the in-vehicle interface 830 can include one or more game or activities interfaces, as described with respect to FIG. 5.

The vehicle manager 840 manages and communicates with the fleet of AVs 110. The vehicle manager 840 assigns the AVs 110 to various tasks and directs the movements of the AVs 110 in the fleet. The vehicle manager 840 includes a vehicle dispatcher 880, an AV interface 885, and a trip sharing manager 890. The vehicle dispatcher 880 selects AVs from the fleet to perform various tasks and instructs the AVs to perform the tasks. The AV interface 885 interfaces with the AVs, and in particular with the video cameras 420, microphones, and other sensors of the sensor suite 140. The trip sharing manager 890 connects AVs in shared trips and manages data flow between the AVs. In some embodiments, the vehicle manager 840 includes additional functionalities. For example, the vehicle manager 840 instructs AVs 110 to drive to other locations while not servicing a user, e.g., to improve geographic distribution of the fleet, to anticipate demand at particular locations, etc. The vehicle manager 840 may also instruct AVs 110 to return to an AV facility for fueling, inspection, maintenance, or storage.

The vehicle dispatcher 880 receives a ride request from the ride request interface 850. The vehicle dispatcher 880 selects one or more AVs 110 to service the ride request based on the information provided in the ride request, e.g., the pickup location, and in some embodiments, a requested number of passengers or number of AVs. The vehicle dispatcher 880 or another system may maintain or access data describing each of the AVs in the fleet of AVs 110, including current location, service status (e.g., whether the AV is available or performing a service; when the AV is expected to become available; whether the AV is schedule for future service), fuel or battery level, etc. The vehicle dispatcher 880 may select AVs for service in a manner that optimizes one or more factors, including fleet distribution, fleet utilization, and energy consumption. The vehicle dispatcher 880 may interface with one or more predictive algorithms that project future service requests and/or vehicle use, and select vehicles for services based on the projections.

The vehicle dispatcher 880 transmits instructions dispatching the selected AVs. In particular, the vehicle dispatcher 880 instructs a selected AV to drive autonomously to the pickup location in the ride request and to pick up the user and, in some cases, additional passengers associated with the ride request. The vehicle dispatcher 880 further instructs the AV to drive autonomously to the destination location.

The AV interface 885 receives data from AVs 110 and, in some cases, transmits data or instructions to the AVs 110. For example, the AV interface 885 receives audio and video captured by the video cameras 420 and microphones in the passenger compartment and, in some cases, audio and/or video captured by external video cameras and microphones mounted on the AV 110. The AV interface 885 provides the audio and video received from one AV to the in-vehicle interface 830 for transmitting to another AV connected in a shared trip via the audio/video module 870, according to instructions from the trip sharing manager 890. The AV interface 885 also receives current locations from the AVs.

The trip sharing manager 890 connects AVs in a shared trip and manages data flow between AVs. The trip sharing manager 890 manages communications between users in setting up a shared trip, as described above with respect to the sharing module 860. The trip sharing manager 890 may reference user data identifying which users are traveling in which AVs, so that the trip sharing manager 890 can direct shared trip requests to the proper AVs. The trip sharing manager 890 may add additional AVs to an existing shared trip using a similar process. For example, if the AVs 110a and 110b are currently in a shared trip, the trip sharing manager 890 receives a request to add a third user in a third AV (e.g., AV 110c) to the shared trip. The request may be provided by one user or AV (e.g., AV 110a) and accepted by the third AV 110c and, optionally, also accepted by AV 110b. In some embodiments, the trip sharing manager 890 automatically connects AVs carrying out a coordinated ride in a shared trip. The provision of and servicing of a coordinated ride is described with respect to FIG. 3.

After the shared trip has been set up, the trip sharing manager 890 stores data identifying groups of AVs engaged in a shared trip. The AV interface 885 and other interfaces, e.g., the in-vehicle interfaces 830 described above, may reference the shared trip information to direct data received at the fleet management system 120 from one AV (e.g., AV 110a) to another AV (e.g., AV 110b). For example, the trip sharing manager 890 directs the in-vehicle interface 830 to transmit audio/video streams received at the AV interface 885 from the first AV 110a to the second AV 110b and vice versa. As another example, the trip sharing manager 890 directs the map module 865 to provide current locations from one or more AVs (e.g., from AV 110a) to one or more AVs in a shared trip (e.g., to AV 110b).

### Example Method for Real-Time Interaction Between AVs

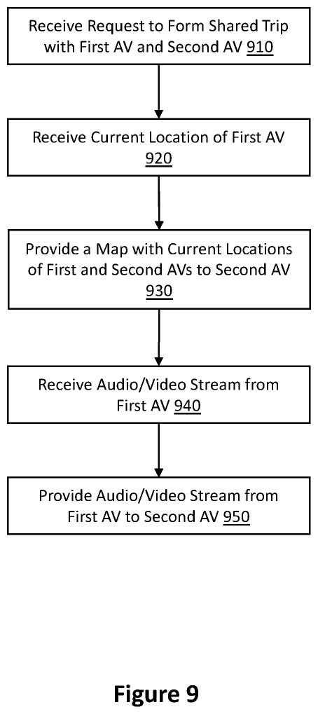

FIG. 9 is a flowchart of an example method for real-time interaction between two AVs according to some embodiments of the present disclosure. A fleet management system receives 910 a request to form a shared trip between a first AV and a second AV. For example, the sharing module 860 receives a request to form a shared trip between the first AV 110a and the second AV 110b and passes the request to the trip sharing manager 890. After forming a shared trip, the fleet management system 120 (e.g., the AV interface 885) receives 920 a current location of the first AV 110a. The current location may have been determined by a location sensor system of the first AV 110a. The fleet management system 120 (e.g., the map module 865) provides 930 a map with the current location of the first AV and the current location of the second AV to an in-vehicle interface of the second AV.

The fleet management system 120 (e.g., the AV interface 885) receives 940 an audio/video stream from the first AV. The audio/video stream may include images captured by an interior camera 420 of the first AV 110a and audio captured by a microphone (e.g., a microphone of the interior camera 420 or a separate microphone) of the first AV 110a. The fleet management system (e.g., the audio/video module 870) provides 950 the audio/video stream to the second AV. The second AV is configured to output the audio/video stream, e.g., using the display screens 430 and speakers 440.

### SELECT EXAMPLES

Example 1 provides a system for providing real-time interaction between two AVs that includes a trip sharing manager, a map module, and an AV interface. The trip sharing manager is configured to receive from a first user traveling in a first AV of a fleet of AVs, a request to join a shared trip with a second user, the second user traveling in a second AV of the fleet of AVs; and, in response to the request, connect the first AV and the second AV in a shared trip. The map module is configured to provide a current location of the first AV to the second AV for display on an in-vehicle interface of the second AV. The AV interface is configured to receive a real-time video stream from the first AV, the real-time video stream captured by a camera in a passenger compartment of the first AV; and provide the real-time video stream to the in-vehicle interface of the second AV.

Example 2 provides the system of according to example 1, where the map module is further configured to receive a first current location from the first AV, receive a second current location from the second AV, generate a map showing the first current location of the first AV and the second current location of the second AV, and provide the map to the in-vehicle interface of the second AV and to an in-vehicle interface of the first AV.

Example 3 provides the system according to example 1, where the second AV is configured to receive the current location of the first AV from the map module; determine, using at least one location sensor, a current location of the second AV; plot the current location of the first AV and the current location of the second AV on a map; and display the map with the current locations of the first AV and the second AV on the in-vehicle interface of the second AV.

Example 4 provides the system according to any of the preceding examples, where the map module is further configured to receive an estimated arrival time of the first AV, the estimated arrival time a time at which the first AV is estimated to reach a destination location; and provide the estimated arrival time of the first AV to the in-vehicle interface of the second AV.

Example 5 provides the system according to any of the preceding examples, the system further including an audio/video module configured to receive a media playback request from the first user traveling in the first AV, and instruct the in-vehicle interface of the second AV to stream media according to the media playback request.

Example 6 provides the system according to any of the preceding examples, the system further including an audio/video module configured to receive a selection of a camera from a plurality of cameras mounted in the first AV to stream to the second user.

Example 7 provides the system according to any of the preceding examples, where the trip sharing manager is further configured to receive a request from the first user to add a third user to the shared trip, the third user traveling in a third AV of the fleet of AVs; and in response to the request to add the third user, connecting the third AV to the shared trip, where the third AV receives a map showing the current location of the first AV and the real-time video stream from the first AV.

Example 8 provides the system according to any of the preceding examples, where the trip sharing manager is further configured to automatically connect a third AV and a fourth AV in a second shared trip, where the second shared trip is a coordinated ride provided by two or more AVs based on a single ride request, a number of passengers transported in the coordinated ride exceeding a passenger capacity for AVs of the AV fleet.

Example 9 provides a system for providing real-time interaction between two AVs that includes a plurality of AVs and a fleet management system. Each of the plurality of AVs includes a location sensor system configured to determine a current location of the AV, at least one interior camera configured to capture images of a passenger of the AV, at least one interior microphone configured to capture audio of the passenger of the AV, and at least one interior display screen configured to provide an in-vehicle interface to the passenger of the AV. The fleet management system is configured to receive an instruction to form a shared trip between a first AV and a second AV of the plurality of AVs; provide a map showing the current location of the first AV and the current location of the second AV to the in-vehicle interface of the second AV; receive an audio/video stream from the first AV, the audio/video stream including images captured by the at least one interior camera and audio captured by the at least one interior microphone; and provide the audio/video stream to the in-vehicle interface of the second AV.

Example 10 provides the system according to example 9, where each of the plurality of AVs further includes an onboard computer configured to detect a location of a passenger seated in the AV; identify an interior camera of a plurality of interior cameras directed at the detected location; and transmit images captured by the identified interior camera to the fleet management system.

Example 11 provides the system according to example 9 or 10, where providing the map showing the current location of the first AV and the current location of the second AV to the in-vehicle interface of the second AV includes receiving, at the fleet management system, the current location of the first AV; and transmitting the current location of the first AV to the second AV, where the second AV is configured to plot the current location of the first AV and the current location of the second AV on the map, and display the map with the current locations of the first AV and the second AV on the in-vehicle interface of the second AV.

Example 12 provides the system according to any of examples 9 through 11, where the fleet management system is further configured to determine an estimated arrival time for the first AV, the estimated arrival time a time at which the first AV is estimated to reach a destination location; and provide the estimated arrival time of the first AV to the second AV for display on the in-vehicle interface.

Example 13 provides the system according to any of examples 9 through 12, where the fleet management system is further configured to receive a media playback request from a first user traveling in the first AV, and instruct the in-vehicle interface of the second AV to stream media according to the media playback request.

Example 14 provides the system according to any of examples 9 through 13, where the the interior display screen is configured to provide a user interface allowing a user to select a camera from a plurality of interior and exterior cameras mounted on the AV to stream to at least one other AV in a shared trip with the AV.

Example 15 provides the system according to any of examples 9 through 14, where the fleet management system is further configured to receive a request from a user in the first AV to add an additional user to the shared trip, the additional user traveling in a third AV of the plurality of AVs; and, in response to the request to add the additional user, connect the third AV to the shared trip, where the third AV receives the map showing the current location of the first AV and the audio/video stream from the first AV.

Example 16 provides the system according to any of examples 9 through 15, where the instruction to form a shared trip between the first AV and the second AV includes a request for a coordinated ride provided by the first AV and the second AV, a number of passengers transported in the coordinated ride exceeding a passenger capacity for AVs of the plurality of AVs.

Example 17 provides a method for real-time interaction between two AVs that includes receiving a request to form a shared trip between a first AV and a second AV of a fleet of AVs; receiving, from the first AV, a current location of the first AV determined by a location sensor system; providing a map showing the current location of the first AV and the current location of the second AV to an in-vehicle interface of the second AV; receiving an audio/video stream from the first AV, the audio/video stream including images captured by at least one interior camera of the first AV and audio captured by at least one interior microphone of the first AV; and providing the audio/video stream to the second AV, the second AV configured to output the audio/video stream on the in-vehicle interface.

Example 18 provides the method according to example 17, the method further including determining an estimated arrival time for the first AV, the estimated arrival time a time at which the first AV is estimated to reach a destination location; and providing the estimated arrival time of the first AV to the second AV for display on the in-vehicle interface.

Example 19 provides the method according to example 17 or 18, the method further including receiving a request from a user in the first AV to add an additional user to the shared trip, the additional user traveling in a third AV of the fleet of AVs; and in response to the request to add the additional user, connecting the third AV to the shared trip, where the third AV receives a map showing the current location of the first AV and the audio/video stream from the first AV.

Example 20 provides the method according to any of examples 17 through 19, where the request to form a shared trip between the first AV and the second AV includes a request for a coordinated ride provided by the first AV and the second AV, a number of passengers transported in the coordinated ride exceeding a passenger capacity for AVs of the AV fleet.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A system for providing real-time interaction between two autonomous vehicles (AVs) comprising:
a trip sharing manager configured to:
receive, from a first user traveling in a first AV of a fleet of AVs, a request to join a shared trip with a second user, the second user traveling in a second AV of the fleet of AVs; and
in response to the request, connect the first AV and the second AV in a shared trip;
a map module configured to provide a current location of the first AV to the second AV for display on an in-vehicle interface of the second AV; and
an AV interface configured to:
receive a real-time video stream from the first AV, the real-time video stream captured by a camera in a passenger compartment of the first AV; and
provide the real-time video stream to the in-vehicle interface of the second AV.

2. The system of claim 1, wherein the map module is further configured to:
receive a first current location from the first AV;
receive a second current location from the second AV;
generate a map showing the first current location of the first AV and the second current location of the second AV; and
provide the map to the in-vehicle interface of the second AV and to an in-vehicle interface of the first AV.

3. The system of claim 1, wherein the second AV is configured to:
receive the current location of the first AV from the map module;
determine, using at least one location sensor, a current location of the second AV;
plot the current location of the first AV and the current location of the second AV on a map; and
display the map with the current locations of the first AV and the second AV on the in-vehicle interface of the second AV.

4. The system of claim 1, wherein the map module is further configured to:
receive an estimated arrival time of the first AV, the estimated arrival time a time at which the first AV is estimated to reach a destination location; and
provide the estimated arrival time of the first AV to the in-vehicle interface of the second AV.

5. The system of claim 1, further comprising an audio/video module configured to:
receive a media playback request from the first user traveling in the first AV; and
instruct the in-vehicle interface of the second AV to stream media according to the media playback request.

6. The system of claim 1, further comprising an audio/video module further configured to:
receive a selection of a camera from a plurality of cameras mounted in the first AV to stream to the second user.

7. The system of claim 1, wherein the trip sharing manager is further configured to:
receive a request from the first user to add a third user to the shared trip, the third user traveling in a third AV of the fleet of AVs; and
in response to the request to add the third user, connecting the third AV to the shared trip, wherein the third AV receives a map showing the current location of the first AV and the real-time video stream from the first AV.

8. The system of claim 1, wherein the trip sharing manager is further configured to automatically connect a third AV and a fourth AV in a second shared trip, wherein the second shared trip is a coordinated ride provided by two or more AVs based on a single ride request, a number of passengers transported in the coordinated ride exceeding a passenger capacity for AVs of the AV fleet.

9. A system for providing real-time interaction between two autonomous vehicles (AVs) comprising:
a plurality of AVs, each AV of the plurality of AVs comprising:
a location sensor system configured to determine a current location of the AV;
at least one interior camera configured to capture images of a passenger of the AV;
at least one interior microphone configured to capture audio of the passenger of the AV; and
at least one interior display screen configured to provide an in-vehicle interface to the passenger of the AV; and
a fleet management system configured to:
receive an instruction to form a shared trip between a first AV and a second AV of the plurality of AVs;
provide a map showing the current location of the first AV and the current location of the second AV to the in-vehicle interface of the second AV;
receive an audio/video stream from the first AV, the audio/video stream comprising images captured by the at least one interior camera and audio captured by the at least one interior microphone; and
provide the audio/video stream to the in-vehicle interface of the second AV.

10. The system of claim 9, wherein each of the plurality of AVs further comprises an onboard computer configured to:
detect a location of a passenger seated in the AV;
identify an interior camera of a plurality of interior cameras directed at the detected location; and
transmit images captured by the identified interior camera to the fleet management system.

11. The system of claim 9, wherein providing the map showing the current location of the first AV and the current location of the second AV to the in-vehicle interface of the second AV comprises:
receiving, at the fleet management system, the current location of the first AV; and
transmitting the current location of the first AV to the second AV, wherein the second AV is configured to plot the current location of the first AV and the current location of the second AV on the map, and display the map with the current locations of the first AV and the second AV on the in-vehicle interface of the second AV.

12. The system of claim 9, wherein the fleet management system is further configured to:
determine an estimated arrival time for the first AV, the estimated arrival time a time at which the first AV is estimated to reach a destination location; and
provide the estimated arrival time of the first AV to the second AV for display on the in-vehicle interface.

13. The system of claim 9, wherein the fleet management system is further configured to:
receive a media playback request from a first user traveling in the first AV; and
instruct the in-vehicle interface of the second AV to stream media according to the media playback request.

14. The system of claim 9, wherein the interior display screen is configured to provide a user interface allowing a user to select a camera from a plurality of interior and exterior cameras mounted on the AV to stream to at least one other AV in a shared trip with the AV.

15. The system of claim 9, wherein the fleet management system is further configured to:
receive a request from a user in the first AV to add an additional user to the shared trip, the additional user traveling in a third AV of the plurality of AVs; and
in response to the request to add the additional user, connect the third AV to the shared trip, wherein the third AV receives the map showing the current location of the first AV and the audio/video stream from the first AV.

16. The system of claim 9, wherein the instruction to form a shared trip between the first AV and the second AV comprises a request for a coordinated ride provided by the first AV and the second AV, a number of passengers transported in the coordinated ride exceeding a passenger capacity for AVs of the plurality of AVs.

17. A method for real-time interaction between two autonomous vehicles (AVs) comprising:
receiving a request to form a shared trip between a first AV and a second AV of a fleet of AVs;
receiving, from the first AV, a current location of the first AV determined by a location sensor system;
providing a map showing the current location of the first AV and the current location of the second AV to an in-vehicle interface of the second AV;
receiving an audio/video stream from the first AV, the audio/video stream comprising images captured by at least one interior camera of the first AV and audio captured by at least one interior microphone of the first AV; and
providing the audio/video stream to the second AV, the second AV configured to output the audio/video stream on the in-vehicle interface.

18. The method of claim 17, further comprising:
determining an estimated arrival time for the first AV, the estimated arrival time a time at which the first AV is estimated to reach a destination location; and
providing the estimated arrival time of the first AV to the second AV for display on the in-vehicle interface.

19. The method of claim 17, further comprising:
receiving a request from a user in the first AV to add an additional user to the shared trip, the additional user traveling in a third AV of the fleet of AVs; and
in response to the request to add the additional user, connecting the third AV to the shared trip, wherein the third AV receives a map showing the current location of the first AV and the audio/video stream from the first AV.

20. The method of claim 17, wherein the request to form a shared trip between the first AV and the second AV comprises a request for a coordinated ride provided by the first AV and the second AV, a number of passengers transported in the coordinated ride exceeding a passenger capacity for AVs of the AV fleet.
